(19) United States
(12) Patent Application Publication
(10) Pub. No.: US 2006/0062231 A1
(43) Pub. Date: Mar. 23, 2006

(54) Packet switching system

(76) Inventors: Andrea Bianco, Torino (IT); Fabio Neri, Turin (IT); Mirko Franceschinis, Torino (IT); Emilio Leonardi, Torino (IT); Stefano Ghisolfi, Torino (IT); Alan Michael Hill, Woodbridge (GB); Terrence Geoffrey Hodgkinson, Woodbridge (GB); Albert Rafel, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/522,729

(22) PCT Filed: Aug. 6, 2003
(86) PCT No.: PCT/GB03/03412

§ 371 Date: Feb. 1, 2005

(30) Foreign Application Priority Data
Aug. 9, 2002 (GB) 0218565.0
Dec. 11, 2002 (GB) 0228917.1
Dec. 11, 2002 (GB) 0228904.9
Dec. 11, 2002 (GB) 0228903.1

(51) Int. Cl. H04L 12/56

(52) U.S. Cl. 370/412

(57) ABSTRACT

Switch requests within a packet switch are allocated by processing switch request data for each input port to generate request data for each input port-output port pairing; and generating an allocation plan by sorting the request data relating to each of the input/output pairs in terms of their queue length, and for each such pair, considered in the sorted order, allocating as many of the requests in the queue as can be accommodated in the remaining time slots.

This invention relates to packet switching systems (also known as cell switching systems) for communications networks, in particular methods for allocating output switching requests for traffic from the inputs of a packet switch to its outputs. Fixed data units (slots) for switching are created by processing input packets as necessary or by any other means such as forecasting.

Input-buffered packet switches and routers offer potentially the highest available bandwidth for any given fabric and memory technology, but such systems require accurate scheduling to make the best use of this bandwidth. In such a scheduling process the header of each incoming packet is processed to identify its destination and the individual packets are then buffered in corresponding input queues, one for each possible pairing of input port with output port (port pair). The scheduling process itself then determines a permutation (a switch configuration or an input/output switch port assignment) in which packets from the input queues should be transmitted such that conflicts do not occur, such as two packets from different inputs competing for the same slot in the output ports.

Many scheduling algorithms only check the occupancy of the first queue position (head of line) from each queue on each cycle, but some check the occupancy of a group of queue positions (known as “frames”) as this is more efficient. A frame-based scheduler determines, in one process, a set of switch permutations (one permutation per slot duration) in the next frame period (the processed/scheduled frame).

Scheduling is one of the most serious limiting factors in Input-Buffered packet switches. Scheduling generally consists of two sub-processes, namely matching (or arbitration), and time slot assignment (or switch fabric path-search). Matching is essentially the selection of packets from the input queues to maximise throughput within the constraints of frame lengths within both input and output ports (the “no-overbooking” constraint). Time slot assignment is the generation of a set of permutations (switching matrix configurations) for routing the packets (slots) through the switch for each slot duration.

A suitable scheduling process must satisfy two conditions; firstly the matching process must ensure that a “no overbooking” criterion is met for each input port and each output port (the “matching” problem). In other words it must arrange that the number of packets to be handled by each port (input and output), will not exceed the frame length (in number of time-slots) during the duration of the frame: ideally it should equal the frame length for each port, but this is not always possible as will be explained. Secondly, the time-slot assignment process must allocate all the matched requests for data units (time slots) for switching (in each permutation) during the frame time period. The present invention relates to the matching step of the scheduling process, which will be described in more detail later, after this overview of the whole packet switching system.

The packets are transmitted along a circuit established through the switch fabric according to a switching matrix (set of permutations) generated in the scheduling process just described. An output buffering stage may be provided in the output line cards before the packets are launched into the output links.

Maximum Size and Maximum Weight bipartite graph matching algorithms exist, which can theoretically achieve 100% throughput, but the complexity of their implementation makes them slow and their application unfeasible. However, although the Maximum Weight algorithm (and sometimes also the Maximum Size algorithm) may solve the scheduling problem they are too complex to use on a per packet basis. There also exist more recent approaches due to Birkhoff and Von Neumann based on request matrix decomposition, but these generate long delays. Hence, iterative, heuristic, parallel algorithms such as the i-SLIP process [N. McKeown, “The i-SLIP scheduling algorithm for input-queued switches”, IEEE Transactions on Networking, vol. 7, no. 2, April 1999] and the Frame-based process have been developed. These heuristic algorithms are faster but, in the nature of heuristic algorithms, they do not provide a rigorous solution.

The “i-SLIP” scheduling algorithm, is an example of one that may operate slot-by-slot, (i.e. with a frame length of a single data unit or time-slot) but alternatively it may use a frame-based approach where input queues' occupancies are each checked once every F time-slots, where the value of F is greater than one: this interval of F timeslots is known as a “frame”. The result of the scheduling process is a N×F Switch Matrix C, where N is the number of the switch input ports, from which switching configurations (set of permutations) are decided for the next frame-switching time period. The content of each element c(i,s) of the matrix C is the Switch Fabric Output Port number to which the “s”th slot of the frame coming from the “i”th input port is to be routed. Note that some elements in matrix C may be empty. Typically there are the same number of output ports as there are input ports (N). This is always likely to be the case unless there is a preponderance of one-way communications connections served by the switch.

The scheduling problem will now be described in more detail.

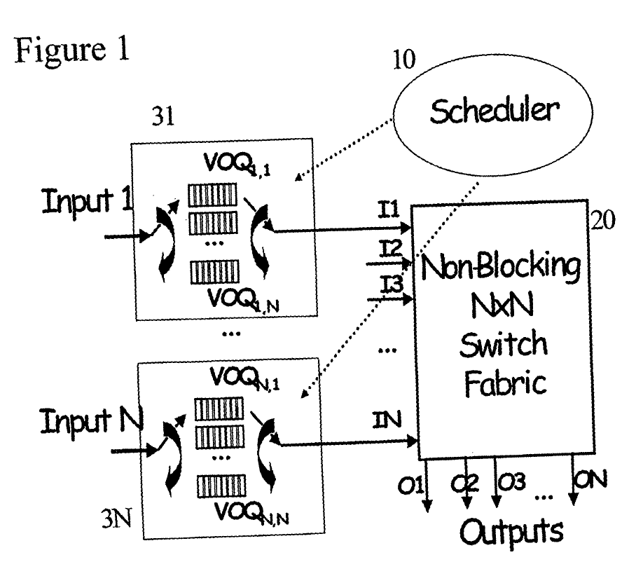

After the required output port of each incoming packet is identified, by processing the header or otherwise, the individual packets are buffered in corresponding input queues depending on the particular requested input/output port pair (VOQ). In order to establish the number of packets (time-slots), a counter is established for each queue (VOQ). Referring to FIG. 1, which shows a typical switch system, the Switch Fabric 20 has N input ports 31 . . . 3N (labelled input I₁ to input I_{N}) and N output ports (labelled output O₁ to output O_{N}). The switching is under the control of a scheduler 10. In respect of each input port “i” the scheduler 10 maintains N queues (one per Output port “j”), labelled VOQᵢⱼ in FIG. 1, in which data units (slots) destined for the respective output port are buffered. Therefore in total there are N² Virtual Output queues, and N² counters.

The number of switching Requests, for each Input port/Output port pair are stored in an N×N Request Matrix R. Each element r(i,j) of this matrix shows the total number of packets pending in the VOQ between input port ‘i’ and output port ‘j’.

In the example to be described below with reference to FIG. 1, a switch fabric with N=4 is used for simplicity, but in a typical switch the value of N is a much larger number. A switching-time period (period for which permutations are decided) is for the duration of one frame (F slots), which can be one or more slots. This means that the matrix R is updated once per frame time-period (with the intention that as many as possible of the packets represented therein, according to the maximum switch capacity, will be switched during the following time period).

$$\begin{matrix}\begin{matrix}{Outlets }^{′} {j}^{′} \to \\ {Inlets }^{′} {i}^{′} ↓\end{matrix} & {O}_{1} & {O}_{2} & {O}_{3} & {O}_{4} \\ {I}_{1} & 3 & 4 & 2 & 0 \\ {I}_{2} & 5 & 0 & 1 & 0 \\ {I}_{3} & 8 & 5 & 1 & 3 \\ {I}_{4} & 2 & 0 & 2 & 6\end{matrix} \\ R = ( \begin{matrix}3 & 4 & 2 & 0 \\ 5 & 0 & 1 & 0 \\ 8 & 5 & 1 & 3 \\ 2 & 0 & 2 & 6\end{matrix} ) \qquad ( 1 )$$

Matrix (1) represents a Request Matrix that will be used in this example, which has no further purpose other than to illustrate the scheduling process. Note that the total number of buffered packets for each port varies, in this example, between six (input I₂ and also output O₃) and eighteen (output O₁), and cannot therefore match the frame size for all ports. Therefore, either some packets will not be switched, (the data either being discarded or held over to the next frame), or some slots will be unused as there are not enough packets to use them all. In general the frame size is predetermined or could vary for each frame-period. Nonetheless it will be fixed for the duration of a frame scheduling.

In the matching process, a number of packets “F” corresponding to the frame length, selected from packets buffered at each input port queue are checked for acceptance, to make sure that there is no overbooking of the input and output ports within the frame. An N×N “Accepted-Requests Matrix” A is defined, whose elements a_{i,j} represent the number of packet switching requests that are accepted from input port ‘i’ destined for output port ‘j’ in the next time period. The two conditions that ensure no overbooking are simply:

$${\sum }_{j = l}^{N} {a}_{i , j} \leq F \text{for all} ⅈ , and {\sum }_{i = l}^{N} {a}_{i , j} \leq F \text{for all} j .$$

Packets destined for overbooked ports may be discarded, or they may continue to be queued for transmission in later frames, if accuracy is more important than latency (delay time).

From the matrix R discussed above, the Matching process populates an N×N Accepted-Requests Matrix A. The values of the elements in this matrix are such that the switch input and output ports capacity is not exceeded, i.e. none of the row and column summations in this matrix exceeds F, which is the number of time slots (data units) that will be switched during the following time period. Note that we can generalise this definition to all Matching Algorithms, whether frame-based or not, saying for example that in a slot by slot process, such as the i-SLIP algorithm, the value of F is unity.

Matrix A below is an illustrative solution to the problem for the requests matrix R from (1). With a switching fabric with N=4 and a frame length F=8, the total switch capacity is N×F time-slots per time-period, which in this example is 32.

$$\begin{matrix}\begin{matrix}{Outlets }^{′} {j}^{′} \to \\ {Inlets}^{′ } {i}^{′} ↓\end{matrix} & {O}_{1} & {O}_{2} & {O}_{3} & {O}_{4} & Row - Sums ↓ \\ {I}_{1} & 2 & 4 & 2 & 0 & 8 \\ {I}_{2} & 3 & 0 & 1 & 0 & 4 \\ {I}_{3} & 2 & 3 & 1 & 2 & 8 \\ {I}_{3} & 1 & 0 & 2 & 5 & 8 \\ Column - Sums \to & 8 & 7 & 6 & 7 & \begin{matrix}Total Sum = 28 \\ NxF = 32\end{matrix}\end{matrix} \\ A = ( \begin{matrix}2 & 4 & 2 & 0 \\ 3 & 0 & 1 & 0 \\ 2 & 3 & 1 & 2 \\ 1 & 0 & 2 & 5\end{matrix} ) \qquad ( 2 )$$

A Matching algorithm attempts to completely fill up the matrix A taking the requests from matrix R, in such a way that the total switching requests for every input and output port does not exceed the value F (No-overbooking), and the total capacity of the Switch (N×F) is achieved. We see that the example shown here has not achieved filling the matrix A to the maximum switch capacity (32 requests), but only 28. In fact, because the input queues are not balanced, it is not possible to fill the remaining four slots in this example.

The solution represented by illustrative matrix A could be achieved reasonably quickly by trial and error from the matrix R. However, in practice switch fabrics have values for N (the number of ports) much greater than the illustrative value of 4 and a systematic approach is required. The present invention presents such an approach. Before the invention is discussed, there follows a description of the subsequent stages in the process.

Usually, the Matching Algorithms only check the occupancy (by inspecting the counters) of the first locations in each virtual output queue, or input-output pair queue (heads of queues) to a maximum of F locations per input port (i.e. all virtual queues corresponding to the same input port), without taking into account all switching requests. There exist some Matching Algorithms that check the occupancy of a higher number of queue locations, for instance a multiple of the value of F. For example, if F=8, we could check occupancy in the first sixteen locations (2F) in each backlogged input queue to try to completely populate the Accepted-Requests Matrix A.

On the other hand, some Matching Algorithms use a number of iterations. This means that the algorithm is run more than once and always using the same queue locations as in the first time. This usually improves the filling ratio of the Accepted-Requests Matrix and therefore the switching throughput. Examples include i-SLIP (i>1), or Frame-based algorithms using some variants of the port pointer update rule [A. Bianco et al., “Frame-based scheduling algorithms for best-effort cell or packet switching”, Workshop on High Performance Switching and Routing, HPSR 2002, May 2002, Japan]. Different versions of the frame-based algorithm have different rules for updating the port pointers and some variants of the frame-based algorithm look twice at the buffer occupancies on the same locations. For example, the versions known as NOB-27 and NOB-25 both use the same update rule but NOB-27 runs part of the process twice on the same buffer locations.

Once the accepted requests matrix A has been generated, the second sub-process in the scheduling algorithm computes the set of switch permutations and assigns the time-slots within a frame to the accepted requests for each one of the permutations. In this way the switch fabric can be configured for each time slot avoiding conflicts at the output ports, i.e. there is at most one packet from any input queue to one particular output port. This process can be referred to as Time Slot Assignment (TSA). From the matrix of accepted requests A, we build the N×F Switch Matrix C. The elements c(i,s) of C show the output port number to which a switching request in input port ‘i’ will be switched in the slot ‘s’ of the frame of length F that is being scheduled. There are a number of algorithms to achieve this, among them the one described in the applicant's existing patent application WO01/67802. Any particular packet should be capable of transmission across the switch fabric during any one of the time slots in the frame, although normally packets from the same queue (that is to say, between the same pair of ports) would be transmitted in the same order that they had originally arrived at the input port.

For example, from the illustrative ‘accepted requests’ matrix A found in (2) the Switch Matrix C shown in (3) might be generated. The columns of matrix C represent the time-slots. At each time-slot the switch fabric has to be configured such that the packets present at the Input Ports are connected to the Output Port shown in each element c(i,s) of matrix C.

$$\begin{matrix}\begin{matrix}Time - {slot}^{′} {s}^{′} \to \\ {Inlet}^{′} {i}^{′} ↓\end{matrix} & {S}_{1} & {S}_{2} & {S}_{3} & {S}_{4} & {S}_{5} & {S}_{6} & {S}_{7} & {S}_{8} \\ {I}_{1} & 1 & 1 & 2 & 2 & 2 & 2 & 3 & 3 \\ {I}_{2} & 3 & & 1 & & 1 & & & 1 \\ {I}_{3} & 2 & 2 & 4 & 4 & 3 & 1 & 1 & 2 \\ {I}_{4} & 4 & 3 & 3 & 1 & 4 & 4 & 4 & 4\end{matrix} \\ C = ( \begin{matrix}1 & 1 & 2 & 2 & 2 & 2 & 3 & 3 \\ 3 & & 1 & & 1 & & & 1 \\ 2 & 2 & 4 & 4 & 3 & 1 & 1 & 2 \\ 4 & 3 & 3 & 1 & 4 & 4 & 4 & 4\end{matrix} ) \qquad ( 3 )$$

Therefore matrix C shows a set of possible switch fabric configurations for an entire frame period. Each column of matrix C shows a switch permutation with no output port conflicts, i.e., no column of matrix C contains more than one occurrence of any output port number. The matrix C is the final result of the entire scheduling problem. Note that where the frame size F=1, as for the “i-SLIP” algorithm, matrix C is a column vector (N×1 matrix), and therefore the time-slot scheduling algorithm is straightforward.

An output memory stage may be provided where the slots could be re-sequenced (re-ordering and/or closing gaps between slots belonging to the same original packet).

Scheduling is therefore made up of the matching problem, and the time slot assignment problem. In the matching problem switching requests are accepted in such a way that the switching capacity is not exceeded while achieving maximum throughput. The assignment problem selects a set of switch fabric configurations (permutations) within the frame-length. This has known exact solutions at acceptable complexities. However, some issues might arise due to slot sequencing that could lead to the necessity for an output memory stage where slots could be re-sequenced.

Although some hitherto known heuristic matching algorithms generally perform well, there are some situations in which their performance deteriorates, in particular with unbalanced traffic patterns and bursty traffic sources. The consequences are that these matching algorithms are unable to ensure the ideal 100% throughput, and therefore some packets will be dropped (lost). This type of situation is becoming increasingly significant, as it is foreseen that the network churn (traffic patterns) will become highly dynamic, and not predictable.

The performance degradation occurs because these algorithms check the queues' occupancy only within a limited number of locations in the input queues. Therefore when a particular input queue backlog keeps growing these algorithms do not necessarily serve it because they are unaware of such condition. This leads to inefficiency becoming apparent at high traffic loads for highly unbalanced traffic patterns, that is, when the number of packets requesting to be switched for one particular or more input-output port pairs is much higher than for the others. This is common to many prior art heuristic matching algorithms as this process only scans the occupancy of a specified limited number of locations in the backlogged input queues, eventually leading to some packets being processed too late in certain traffic conditions.

According to the invention, there is provided a method of allocating switch requests within a packet switch, the method comprising the steps of

(a) generating switch request data for each input port indicative of the output ports to which data packets are to be transmitted;

(b) processing the switch request data for each input port to generate request data for each input port-output port pairing; and

(c) generating an allocation plan by sorting the request data R relating to each of the input/output pairs in terms of their queue backlog length, and

(d) for each input/output pair, considered in the sorted order, allocating as many of the requests in the queue as can be accommodated in the remaining time slots.

Queue backlog length is a measure of urgency—the number of packets waiting to be routed is determined by the rate at which the packets are arriving in the input ports, and how long they are having to wait.

The invention extends to a method of packet switching wherein the packets are switched on the basis of the allocated routing, and to a packet switch in which the input port-output port routing is allocated in accordance with the method of the invention, and packets are switched from an input port to a specified output port in accordance with the allocated routing.

In this way all requests can be considered within one scan. An input or output port may be used more than once in the same scan, if the relevant frame was not filled by the first entry to use it.

Unallocated switch requests may be reserved for use in the next phase of switch request allocation, or abandoned if they have an expiry time.

A preliminary stage may be carried out, in which for each row the number of requests of each element of that row is reduced by a factor such that the row is not “overbooked”—that is to say, the number of requests relating to the port to which that row relates is no greater than the frame length. Alternatively, this preliminary stage may be performed on each column instead of each row. In another variant, all the elements in the request matrix may be reduced by a single common factor such that no row or column exceeds the frame length.

This preliminary step has no effect on the order in which the ports are considered, but ensures that the available slots are distributed amongst all the queues requesting them. This step is described in detail in the applicant's two International applications both filed on the same date as the present application, namely A30156WO (claiming priority from United Kingdom applications 0218565.0 and 0228904.9), and A30169WO (claiming priority from GB0218565.0 and GB0228917.1).

An embodiment of the invention will now be described, by way of example, with reference to the drawings, in which

FIG. 1, which has already been discussed, illustrates a simplified packet switching system;

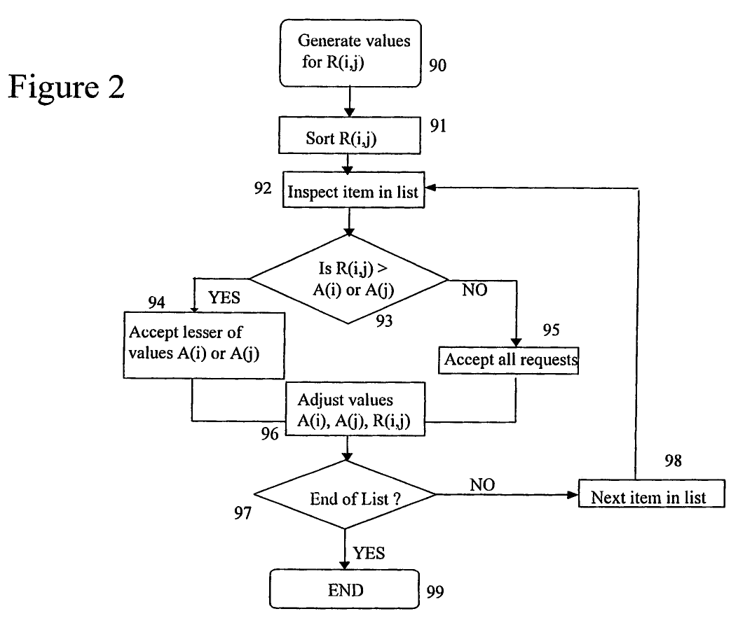

FIG. 2 is a flow chart illustrating the operation of the invention

The initial step 90 is to generate, for each input port/output port pair (i,j), the queue size value R(i,j). These values are then sorted into descending order (step 91). The first (largest) queue occupancy is then inspected (step 92), and compared with the number of slots A(i),A(j) remaining available for the respective input and output port (step 93). Initially the values A(i) and A(j) will be equal to the frame length F for all the ports i and j.

If the value R(i,j) is less than or equal to the number of available slots A(i) in the respective input port i, and also less than or equal to the number of available slots A(j) in the respective output port j, then all the requests are accepted and allocated to the respective ports (step 95).

If the value R(i,j) is greater than either the number of available slots A(i) in the respective input port I, or greater than the number of available slots A(j) in the respective output port j, the number of requests which are accepted is the lesser of those two values A(i) or A(j) (step 94). Note that this number may be zero.

The values of A(i), A(j) and R(i,j) are then reduced by the number of requests accepted (step 96). The value of R(i,j) will therefore become zero if all requests from the respective queue are accepted. The value of A(i) or A(j) will become zero if acceptance of the request brings the total number of accepted requests relating to that port up to the frame length F.

Next a check is made (step 97) to determine if there are any more non-zero terms R(i,j). If there are further terms, the process is repeated for the next term (step 98). If not, the process has been completed (step 99). The process may also be terminated if all values of A(i) and A(j) equal zero.
The following example is an implementation of the present invention with frame length F=8 and the following switch request matrix example, in which there are, as before, four input ports and four output ports. The frame length F is again 8.

$$\begin{matrix}\begin{matrix}{Outlets}^{′} {j}^{′} \to \\ {Inlets}^{′} {i}^{′} ↓\end{matrix} & {O}_{1} & {O}_{2} & {O}_{3} & {O}_{4} & \\ {I}_{1} & 3 & 4 & 2 & 0 & \\ {I}_{2} & 5 & 0 & 1 & 0 & \\ {I}_{3} & 8 & 5 & 1 & 3 & \\ {I}_{4} & 2 & 0 & 2 & 6 & \\ & & & & & \end{matrix} giving a request matrix \\ {R}_{0} = [ \begin{matrix}3 & 4 & 2 & 0 \\ 5 & 0 & 1 & 0 \\ 8 & 5 & 1 & 3 \\ 2 & 0 & 2 & 6\end{matrix} ] \qquad ( 4 )$$

In the table below the elements of the matrix have been sorted by queue length. Each element in turn is then used to fill as many slots as possible without exceeding the frame size for either the input frame or the output frame.

| Input | Output | Queue | Number | Cumulative | Cumulative | Remaining |
|---|---|---|---|---|---|---|
| Element | Element | Size Rₒ | selected | totals: inputs | tot'l: outputs | in queue |
| 3 | 1 | 8 | 8 | 0 0 8 0 | 8 0 0 0 | 0 |
| 4 | 4 | 6 | 6 | 0 0 8 6 | 8 0 0 6 | 0 |
| 2 | 1 | 5 | 0 | 0 0 8 6 | 8 0 0 6 | 5 |
| 3 | 2 | 5 | 0 | 0 0 8 6 | 8 0 0 6 | 5 |
| 1 | 2 | 4 | 4 | 4 0 8 6 | 8 4 0 6 | 0 |
| 1 | 1 | 3 | 0 | 4 0 8 6 | 8 4 0 6 | 3 |
| 3 | 4 | 3 | 0 | 4 0 8 6 | 8 4 0 6 | 3 |
| 1 | 3 | 2 | 2 | 6 0 8 6 | 8 4 2 6 | 0 |
| 4 | 1 | 2 | 0 | 6 0 8 6 | 8 4 2 6 | 2 |
| 4 | 3 | 2 | 2 | 6 0 8 8 | 8 4 4 6 | 0 |
| 2 | 3 | 1 | 1 | 6 1 8 8 | 8 4 5 6 | 0 |
| 3 | 3 | 1 | 0 | 6 1 8 8 | 8 4 5 6 | 1 |

| | | | | | |
|---|---|---|---|---|---|
| OTHER ELEMENTS | 0 | 0 | 6 1 8 8 | 8 4 5 6 | 0 |

| | |
|---|---|
| Number of slots filled | 23 |

It will be seen that the first two elements to be considered, elements (3,1) and (4,4) can be used in full, but the next two elements (2,1) and (3,2) cannot be used at all, in one case because the required output port 1 is already full, and in the other because the required input port 3 is already full. Continuing down the queue, note that elements (1,3) (4,3) and (2,3) add further slots to frames which are already partially full.
The resulting Accepted Request Matrix A is thus

$$A = [ \begin{matrix}0 & 4 & 2 & 0 \\ 0 & 0 & 1 & 0 \\ 8 & 0 & 0 & 0 \\ 0 & 0 & 2 & 6\end{matrix} ]$$

On the next frame, the process is repeated, but now different elements have the longest queues and are considered first. In the absence of any new requests, these would be elements (2,1) and (3,2).

Table 1 below presents a comparison of the results using the present invention with the results obtained by using various prior art processes. The present invention is used on its own, either once or twice, and also preceded by two different normalisation methods, which are the subject of the applicant's co-pending United Kingdom patent applications having applicant's references A30156 and A30169 referred to above, both filed on the same day as this application. Normalisation method 3 assigns a separate ‘mval’ in the row and column for each r_{i,j} matrix entry. This means that some matrix entries could be rounded down twice. Normalisation 2 assigns the larger of the row and column ‘mval’ for each matrix entry. By assigning only one ‘mval’ to each matrix entry, each one is rounded down only once.

Comparative data is shown for two other processes. As well as the present invention, data is shown for the process of the applicant's co-pending application WO01/67803, (the latter using the NOB-25 rule) and another algorithm known as “Ring” which was proposed by Politecnico di Torino within the European Union's collaborative project DAVID [“Description of Network Concepts and Frame of the Work”, DAVID (IST-1999-11742) project Deliverable D1, March 2002]. This ‘Ring’ algorithm is a “greedy” maximal approximation of a maximum weight matching [R. E. Tarjan, “Data Structures and Network Algorithms”, Society for Industrial and Applied Mathematics, November 1983], a well known problem in graph theory.

The resulting Accepted-Requests Matrices A for each combination shown in Table 1 are shown in Table 2. In this example it is seen that the examples using a preliminary stage of the normalisation process 2 (examples d,e, and f) and Normalisation Process 3 (examples g, h, and 1) provide a higher filling cardinality than those which do not. Of those, the Frame-based algorithm (using NOB25 rule) process (examples f and i) generate a larger number of filled requests, (up to 28) but the filled matrices of the “Ring” process, (examples d and g) and of the applicant's co-pending application A30156 referred to above (examples e and h) provide a better match to the proportions of the original Request matrix R₀.

In these examples it is seen that examples f,i, which use the Frame-based process with NOB25 pointer update rule, generate a larger number of filled requests (28), but that the filled matrices do not provide such a good match to the proportions of the original Request matrix R₀ as do those of the present invention (examples a, c, e, and h). The “Ring” Process (examples b,d,g) produces similar results, but because it only attempts to fill a maximum of one slot on each iteration of the process, it is considerably slower than the present invention, which attempts to fill as many slots as possible.

TABLE 1
Comparison of different combinations of algorithms in
a two-stage implementation of the present invention.

| | | | Cardinality |
|---|---|---|---|
| | Stage 1 | Stage 2 | (No of Accepted Requests) |
| a) | (No first stage) | This Invention | 23 |
| b) | Ring | Ring | 25 |
| c) | This Invention | This Invention | 23 |
| d) | Normalisation2 | Ring | 26 |
| e) | Normalisation2 | This Invention | 26 |
| f) | Normalisation2 | WO01/67803 | 28 |
| g) | Normalisation3 | Ring | 27 |
| h) | Normalisation3 | This Invention | 27 |
| i) | Normalisation3 | WO01/67803 | 28 |

TABLE 2
Accepted-Requests Matrices, using the different
combinations of Table 1.

| A = | | |
|---|---|---|
| a) | b) | c) |
| $[ \begin{matrix}0 & 4 & 2 & 0 \\ 0 & 0 & 1 & 0 \\ 8 & 0 & 0 & 0 \\ 0 & 0 & 2 & 6\end{matrix} ]$ | $[ \begin{matrix}0 & 4 & 2 & 0 \\ 2 & 0 & 1 & 0 \\ 6 & 2 & 0 & 0 \\ 0 & 0 & 2 & 6\end{matrix} ]$ | $[ \begin{matrix}0 & 4 & 2 & 0 \\ 0 & 0 & 1 & 0 \\ 8 & 0 & 0 & 0 \\ 0 & 0 & 2 & 6\end{matrix} ]$ |
| d) | e) | f) |
| $[ \begin{matrix}1 & 4 & 2 & 0 \\ 2 & 0 & 1 & 0 \\ 5 & 2 & 0 & 1 \\ 0 & 0 & 2 & 6\end{matrix} ]$ | $[ \begin{matrix}1 & 4 & 2 & 0 \\ 2 & 0 & 1 & 0 \\ 5 & 2 & 0 & 1 \\ 0 & 0 & 2 & 6\end{matrix} ]$ | $[ \begin{matrix}2 & 4 & 2 & 0 \\ 3 & 0 & 1 & 0 \\ 3 & 2 & 1 & 2 \\ 0 & 0 & 2 & 6\end{matrix} ]$ |
| g) | h) | i) |
| $[ \begin{matrix}1 & 4 & 2 & 0 \\ 3 & 0 & 1 & 0 \\ 4 & 3 & 0 & 1 \\ 0 & 0 & 2 & 6\end{matrix} ]$ | $[ \begin{matrix}1 & 4 & 2 & 0 \\ 3 & 0 & 1 & 0 \\ 4 & 3 & 0 & 1 \\ 0 & 0 & 2 & 6\end{matrix} ]$ | $[ \begin{matrix}2 & 4 & 2 & 0 \\ 3 & 0 & 1 & 0 \\ 2 & 3 & 1 & 2 \\ 0 & 0 & 2 & 6\end{matrix} ]$ |

1. A method of allocating switch requests within a packet switch, the method comprising the steps of
(a) generating switch request data for each input port indicative of the output ports to which data packets are to be transmitted;
(b) processing the switch request data for each input port to generate request data for each input port-output port pairing; and
(d) generating an allocation plan by sorting the request data R relating to each of the input/output pairs in terms of their queue length, and
(e) for each input/output pair, considered in the sorted order, allocating as many of the requests in the queue as can be accommodated in the remaining time slots.

2. A method of packet switching wherein the packets are switched on the basis of the allocated routing, and to a packet switch in which the input port-output port routing is allocated in accordance with claim 1, and packets are switched from an input port to a specified output port in accordance with the allocated routing.

3. A method according to claim 1, in which unallocated switch requests are reserved for use in the next phase of switch request allocation, or abandoned if they have exceeded a predetermined expiry time.

4. A method according to claim 1, comprising a preliminary stage in which the number of requests for each input or output port is reduced by a factor such that the number of requests relating to that port is no greater than the number of available time slots.

5. A method according to claim 1, comprising a preliminary stage in which the number of requests in respect of each input/output pair are reduced by a single common factor such that the number of requests relating to all ports is no greater than the number of available time slots.

6. A method of packet switching wherein the input port-output port routing is allocated according to the method of claim 1 and the packets are switched on the basis of the allocated routing.

7. A packet switch in which the input port-output port routing is allocated in accordance with the method of claim 1.

8. A packet switch according to claim 7, wherein packets are switched from an input port to a specified output port in accordance with the allocated routing.
